(19) United States
(12) Patent Application Publication
(10) Pub. No.: US 2025/0339884 A1
(43) Pub. Date: Nov. 6, 2025

(54) OCCLUDING PURGE VENTURI SYSTEMS AND METHODS OF USE THEREOF

(71) Applicant: Emerging Acquisitions, LLC, Eugene, OR (US)

(72) Inventors: Kienan Cree Brotherton, Eugene, OR (US); Jonathan Thomas Brooks, Nashville, TN (US)

(73) Assignee: Emerging Acquisitions, LLC, Eugene, OR (US)

(21) Appl. No.: 19/197,829

(22) Filed: May 2, 2025

Related U.S. Application Data
(60) Provisional application No. 63/642,644, filed on May 3, 2024.

(51) Int. Cl. B08B 9/043; B08B 13/00; B25J 15/06

(52) U.S. Cl. CPC B08B 9/0436; B08B 13/00; B25J 15/0616; B08B 2209/04

(57) ABSTRACT

The systems and methods relate to high-speed object manipulation using a vacuum system in combination with an occluding purge assembly. This system addresses the technical problem of blockages caused by debris or contaminants in open-to-atmosphere venturi systems. The solution involves an occluding purge assembly that seals the exhaust port, allowing the venturi module to expelling obstructions with high pressure. The apparatus includes a controller to transition the purge assembly between open and closed configurations, and may feature sensors for monitoring pressure and detecting blockages. Additionally, an automated cleaning system can be integrated to remove contaminants, ensuring continuous efficiency.

### CROSS-REFERENCE TO RELATED APPLICATIONS

This application claims the benefit of U.S. Provisional Patent Application No. 63/642,644, filed May 3, 2024. The prior application is incorporated herein by reference in its entirety.

### FIELD OF INVENTION

The present disclosure relates to systems and methods for high-speed object manipulation using vacuum-based technologies.

### BACKGROUND

Venturi vacuum generators are widely used across various industries, particularly in pick- and—place applications. While there are many types of ventures, they are optimized for the inverse relationship between producing vacuum pressure and vacuum flow. A multi-stage venturi optimizes maximum vacuum while producing less vacuum flow compared to a pass-through, which produces high vacuum flow at a reduced maximum vacuum level.

However, a common trait among all venturi types in pick-and-place applications is that they are open-to-atmosphere. Consequently, these systems face challenges related to potential blockages or reduced performance due to debris or contaminants entering the vacuum ports. This is especially true in environments where the material being handled can be highly contaminated. For examples, such environments can introduce sticky particles into the airstream, resulting in a buildup of viscous sludge or completely clogging the venturi with malleable residue, often necessitating human intervention to disassemble and clean the venturi or unclog jammed material.

Accordingly, there is a need for advanced systems and methods that address contaminant problems, such as clogging, thereby enhancing system reliability and ensuring uninterrupted high-speed object manipulation.

### SUMMARY

The systems and methods disclosed herein relate to systems, and the operations thereof, for high-speed object manipulation using a vacuum system and an occluding purge assembly.

In one embodiment, the disclosure provides an apparatus for high-speed object manipulation that includes a venturi module configured to generate a vacuum flow for object acquisition. The venturi module comprises an inlet to receive compressed air, a vacuum port incorporating a suction member, and an exhaust port. An occluding purge assembly operably coupled to the venturi module features a passageway that can be selectively closed to seal the exhaust port from atmospheric exposure. A controller is configured to cause the occluding purge assembly to transition between a configuration with an open passageway and a configuration where the passageway is closed. In various embodiments, the occluding purge assembly may be a pinch valve or a device selected from an angle seat valve, a slide gate, or an iris diaphragm valve, and when closed, the assembly acts to seal the exhaust port so that the venturi module operates as a pressure vessel with an internal pressure corresponding to the compressed air supplied. The apparatus may further include one or more sensors configured to monitor pressure at the vacuum and exhaust ports so that the controller can activate the occluding purge assembly in response to a detected blockage. Other embodiments incorporate a venturi module having a substantially constant inside diameter from the inlet to the exhaust port, and include an automated cleaning system-such as one with a brush on a shaft that can pass through the occluding purge assembly—to remove accumulated contaminants. In certain embodiments, the occluding purge assembly is actuated by a pneumatic or a mechanical input, may include an integrated sensor to determine sealing effectiveness, and can be supplemented with a secondary compressed air input during the purging process.

In another embodiment, the disclosure provides a method for purging contaminants from a venturi-based vacuum system for high-speed object manipulation. The method comprises supplying compressed air to a venturi device having an inlet for receiving the air, a vacuum port with a suction member, and an exhaust port open to atmospheric exposure, and generating a vacuum flow to acquire an object or admit contaminants. The method further includes detecting a blockage indicative of contaminant accumulation or object retention and, while maintaining the compressed air supply, activating an occluding purge device to seal the exhaust port from atmospheric exposure; this causes the compressed air to be redirected toward the vacuum port to expel the object or contaminants. In some embodiments, the method further comprises monitoring pressure parameters at the vacuum and exhaust ports using sensors, actuating the occluding purge device through a pneumatic or mechanical input, supplementing the primary compressed air with a secondary input, determining the sealing effectiveness of the purge device via integrated sensors, and operating an automated cleaning system to remove accumulated contaminants after expelling. Additionally, detecting the blockage may include comparing a measured pressure differential between the vacuum and exhaust ports to a predetermined threshold indicative of contaminant accumulation.

### BRIEF DESCRIPTION OF THE FIGURES

FIG. 1 illustrates a schematic flow chart diagram of the method for purging contamination from a venturi system.

FIG. 2 is a schematic diagram illustrating the occluding purge device integrated into the venturi system for object manipulation, shown with the occluding purge device in an open (i.e., inactivated) configuration.

FIG. 3 is a schematic diagram illustrating the occluding purge device integrated into the venturi system for object manipulation, shown with the occluding purge device in a closed (i.e., activated) configuration.

FIG. 4 is a cross-sectional system diagram illustrating the occluding purge device integrated with the venturi for object manipulation and contaminant expulsion, shown with the occluding purge device in an open (i.e., inactivated) configuration.

FIG. 5 is a cross-sectional system diagram illustrating the occluding purge device integrated with the venturi for object manipulation and contaminant expulsion, shown with the occluding purge device in a closed (i.e., activated) configuration.

FIG. 6 is a schematic diagram illustrating the venturi's interaction with contaminants within the system.

FIG. 7 is a system diagram illustrating a cleanout system and an occluding purge venturi systems.

FIG. 8 is a cross-sectional view of FIG. 7.

FIG. 9 is a cross-sectional view illustrating the cleanout system of FIG. 8 interacting with the occluding purge venturi system.

FIG. 10 is a system diagram illustrating the integration of a robotic system with an occluding purge venturi system and a cleanout system.

FIG. 11 is a schematic flow chart diagram illustrating the process for maintaining venturi performance and object manipulation efficiency.

FIG. 12 illustrates a schematic diagram of a system designed for high-speed object manipulation using a venturi-based vacuum system.

FIG. 13 illustrates a sectional view of the system disclosed in FIG. 12.

FIG. 14A illustrates a sectional view of an embodiment of the system disclosed herein, taken from C-C of FIG. 12.

FIG. 14B illustrates a sectional view of an embodiment of the system disclosed herein, taken from D-D of FIG. 12.

FIG. 15A illustrates a first view of another exemplary screen according to an embodiment disclosed herein.

FIG. 15B illustrates a second view of the exemplary screen of FIG. 15A.

FIG. 16A illustrates a first view of another exemplary screen according to an embodiment disclosed herein.

FIG. 16B illustrates a second view of the exemplary screen of FIG. 16A.

### DETAILED DESCRIPTION

### Introduction

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Features and characteristics described in conjunction with a particular aspect, embodiment or example are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are relatively discernable by one of ordinary skill in the art.

As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.” As used herein, the term “coupled” generally means physically, chemically, electrically, magnetically, or otherwise coupled or linked and does not exclude the presence of intermediate elements between the coupled items absent specific contrary language.

This design focuses on the fundamental concept of conventional vacuum material handling, which involves creating low pressure to generate lift and holding force. These factors are determined by the “vacuum flow” and “vacuum pressure” produced by the vacuum generator.

As used herein, “vacuum flow” refers to the volume of air or gas that is moved through a vacuum system over a given period, typically measured in cubic feet per minute (CFM) or liters per second (L/s). As used herein, “vacuum pressure” is a measure of the force exerted by the vacuum system, typically expressed in units such as pascals (Pa) or inches of mercury (inHg).

As used herein, “occluding device” refers to a structure and/or mechanism that blocks or seals an opening or passageway, preventing the flow of air, liquid, or other substances through it.

As used herein, the term “occluding purge venturi system” refers to a venturi system that incorporates an occluding device that can close off the venturi from the atmosphere.

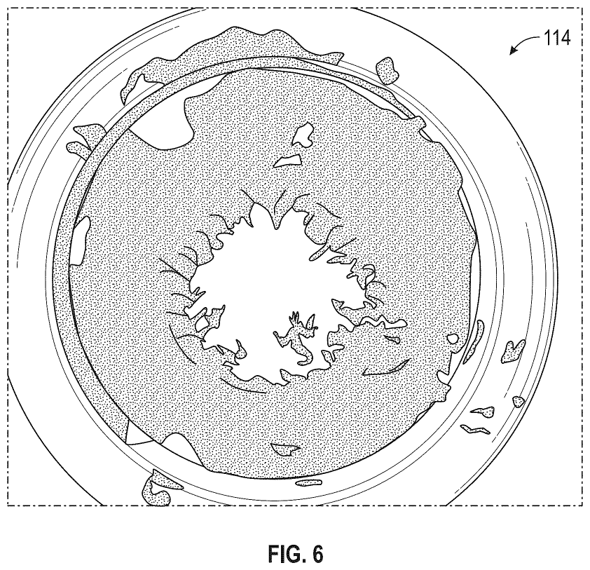

As used herein, the term “contaminant” refers to any substance or material that can interfere with normal operations of the systems described herein, leading to blockages, reduced efficiency, and/or damage, including, for example, built up contamination (e.g., as shown in FIG. 6) and malleable ingress contamination (e.g., as shown in FIG. 5).

The occluding purge venturi systems described herein comprise an occluding purge device combined with a venturi system capable of sealing off an otherwise open-to-atmosphere vacuum systems. Engineered to prevent clogging or obstructions within the vacuum system without necessitating manual intervention, the device minimizes downtime and maintains system efficiency. The design can be particularly suitable for environments that have a high particulate matter rich air environments, where unknown materials are presented to the vacuum acquisition device and cleanliness is not controlled.

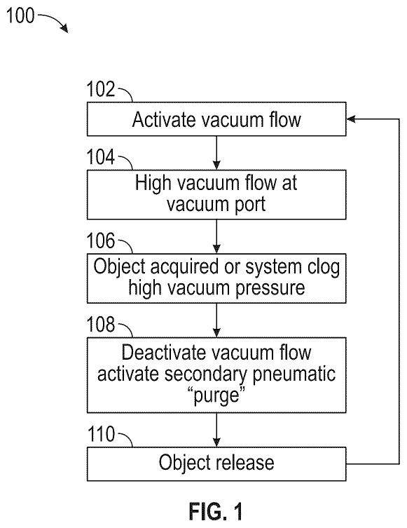

When a vacuum system encounters malleable plastics or textiles, it impedes the system's ability to facilitate effective vacuum flow through the suction device, thus obstructing the acquisition of desired objects. FIG. 1 illustrates a method 100 of using a pneumatic blowout feature to purge materials. At step 102, the method begins with the activation of vacuum flow within the venturi system. This step initiates the process of generating vacuum pressure and flow necessary for object acquisition and manipulation. At step 104, high vacuum flow is established at the vacuum port, enabling the system to acquire objects or potentially encounter a system clog. The vacuum pressure increases as the venturi operates, facilitating the capture of objects at the suction member. At step 106, the method addresses the scenario where an object is acquired or a system clog occurs, resulting in high vacuum pressure. This step highlights the challenge of maintaining system efficiency when obstructions impede the vacuum flow. At step 108, the method involves deactivating the vacuum flow and activating a secondary pneumatic purge to reverse the airflow and expelling contaminants or obstructions from the venturi system, thereby clearing the clog. At step 110, the method concludes with the release of the object. The activation of the secondary purge air line facilitates the normalization of static pressure, allowing the object to be released from the suction cup and restoring the system to an operational state. This approach, however, can be ineffective for densely compacted clogs.

An elevated vacuum can result in the inadvertent intake of materials such as films, strings, and textiles, which subsequently become compressed at the end-effector, screen, or within the hose. Once an object or contaminant is captured within the system, the vacuum pressure embeds the contamination further, compacting the foreign object and ultimately resulting in device clogging. This occurs because the venturi remains open to atmosphere; when a clog becomes compacted, the purge air simply flows along the path of least resistance and is directed at the venturi exhaust, resulting in the purge only briefly exerting the force of its momentum on the clog before being redirected.

One approach in harsh industrial environments is to use a variable pass-through venturi with a built-in purge feature, which on average is more effective without a filter or screen. However, it still faces the same issue of a compacted clog; the purge is unable to expel the contamination effectively, leading to a continuous buildup of sludge and reducing overall performance.

Filter screens have been employed to prevent the ingress of malleable objects into the vacuum system. However, in harsh environments, the utilization of a pneumatic purge feature exacerbates the issue. Upon depressurizing the vacuum system to release the object, malleable contamination becomes embedded in the opposite direction of the vacuum flow, as activated by the pneumatic purge feature. Consequently, as the grasping device continues its operations and vacuum pressure cycles, it perpetuates the embedding and entangling of contamination within the screen.

Environmental factors that result in a buildup of viscous sludge inside the venturi greatly reduce the capacity of the vacuum generators to produce vacuum flow and vacuum pressure. This can require human intervention to disassemble and clean the system due to the venturi design not accommodating an automated solution.

The design is focused on the concept of purging contamination fully embedded in an open-to-atmosphere vacuum system by sealing the system to atmosphere to purge the embedded object by spiking the pressure, forcibly ejecting the blockage. This approach differs from the industry standard of applying compressed air to the open-to-atmosphere, creating backflow through the system.

Incorporating design features that allow for an automated supporting cleaning system will enable the system to perpetually maintain its effectiveness.

### Exemplary Embodiments

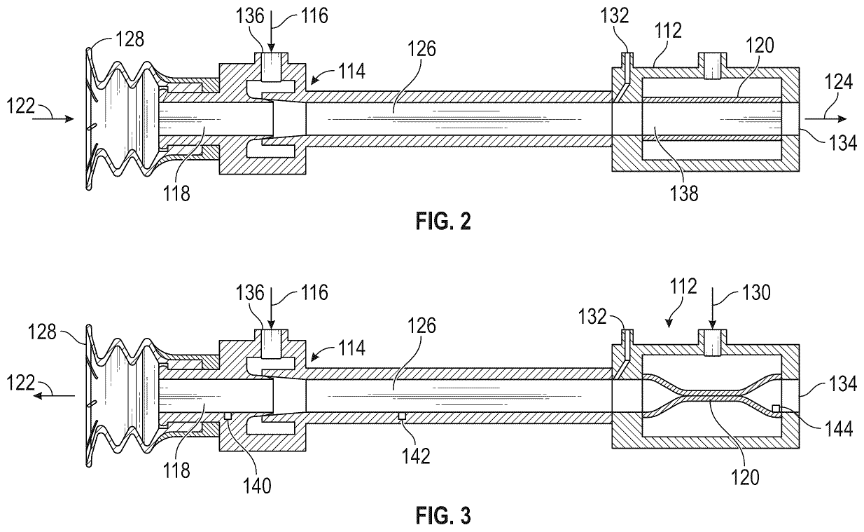

FIGS. 2 and 3 illustrate an occluding purge venturi system that incorporates an occluding purge device 112 with a venturi system 114. The occluding purge venturi system is capable of normal operation in which the venturi is open to the atmosphere (e.g., FIG. 1). However, when the occluding purge device 112 is activated, the occluding purge device 112 seals the exhaust line 126 of the venturi to the atmosphere, resulting in the venturi air supply 116 (e.g., compressed inlet air) being forced to redirect to a vacuum port 118 (e.g., a vacuum nozzle).

The occluding purge device 112 comprises a mechanism integrated into the system, such as a pinch valve, angle seat valve, slide gate, iris diaphragm valve, or any similar device capable of sealing the flow of air with little to no impact on head loss compared to a straight pipe. In FIGS. 1 and 2, the occluding purge device 112 includes a pinch valve 120.

The outlined design of the invention utilizes a pass-through venturi 114 with a limited length of vacuum or exhaust hose line with an inside diameter that remains constant. While this may reduce the overall performance of the classical venturi, it allows the complete system to sustain a high-performance factor when paired with the automatic cleaning device. Although illustrated as a generally straight inner diameter, in some embodiments the path of the inner diameter may be curved, angled, or otherwise non-linear. For example, in some embodiments, the pinch valve may be angled relative to the inlet pipe to handle ejected contaminants (e.g., debris).

As compressed air 116 is applied to the venturi 114, a vacuum flow 122 is produced, with an exhaust flow 124 passing out of an exhaust line 126. As shown in FIG. 2, when the occluding purge device 112 is open, the exhaust flow 124 passes through a passage 138 of the occluding purge device 112 and out an exit area 134. This allows the device to acquire an object at a suction member 128, resulting in a flow blockage and producing high vacuum at the suction member. To release the object, the air input to the venturi 114 is not deactivated, unlike in a conventional venturi. Instead, as shown in FIG. 3, the occluding purge device 112 can be activated, such as by a pneumatic input 130. The device activation is not limited to pneumatic input but can also be mechanical or any other suitable activating action. Upon activation, the passage 138 closes and the exhaust line 126 is sealed off from the atmosphere, forcing the compressed air 116 to be redirected to the vacuum port 118. This effectively produces a similar inverted flow to that of a traditional purge of a secondary compressed air line. However, by not deactivating the compressed air 116, this instigates an almost instantaneous normalization of the static pressure, releasing the object held at the suction member 128.

In some embodiments, a secondary pneumatic purge port 132 can be incorporated to supplement the compressed air supplied at the venturi input port 136.

To get information about the operation of the occlusion venturi device sensor port are added at critical points to interpolate grasping performance as well as maintenance requirements. A vacuum sensor 140 can be integrated into the vacuum port 118 to monitor the pressure within the vacuum port 118 (e.g., a first end of the air passageway). A pressure sensor 142 can be incorporated into the exhaust line 126, connecting with a purge sensor to monitor the pressure when a blockage is observed at the vacuum inlet port 118. A pressure sensor 144 can also be incorporated into the occluding device 112, connecting with a device sensor to monitor the pressure within the occluding device 112 (e.g., within pinch valve 120) to monitor if the valve is functioning properly and/or needs to be replaced. A controller oversees the pressure readings from all sensors, enabling it to facilitate maintenance needs and interpolate performance data.

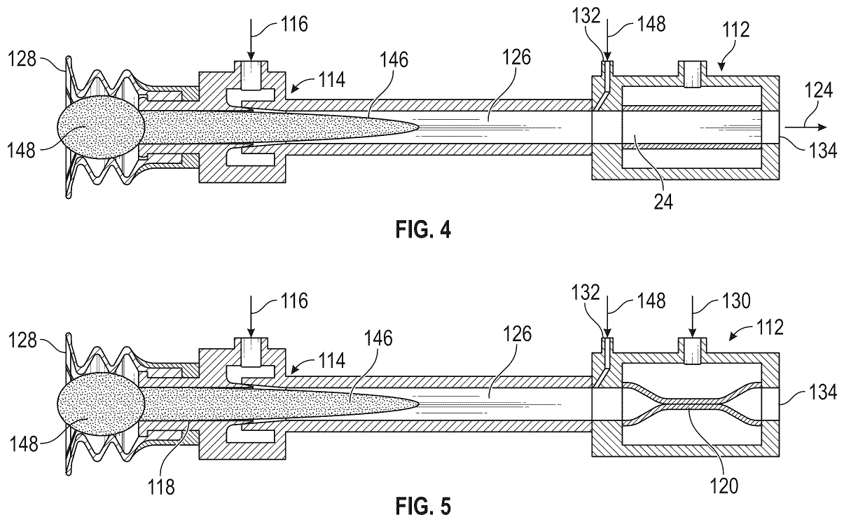

Referring to FIG. 4, during operation, situations may arise where an object becomes stuck in the system. Such items typically fall into the category of malleable materials with a high surface area, such as but not limited to film, fiber, or textiles. While a pass-through venturi allows small items to simply traverse the system and be ejected with the exhaust, there are exceptions as outlined that can result in a clogged system. The issue is then exacerbated by the vacuum that draws in the malleable contamination, elongating, for example, a contamination 146 tell fully imbedded into the device.

When an object 148 becomes lodged during the vacuum phase of the pick-and-place application and a secondary purge port 132 is activated by directing compressed air 148, when the occluding device 112 is open, the airflow is redirected to exit area 134, resulting in minimal force being applied to the blockage in the venturi 114. This minimal force can be calculated as the air momentum applied to the cross-sectional area as the exhaust port tries to normalize to atmosphere.

Referring to FIG. 5, when the occluding device 112 is activated, however, the device changes the dynamics of the system to a static pressure system. By activating the occluding device 112, the venturi 114 is sealed off from atmosphere. With the compressed air 116 input at the venturi 114 (e.g., operating at 90 psi), and the occluding device 114 sealing the exhaust line 126, the system is now modeled as a pressure vessel, and the static pressure will increase until normalized (e.g., to 90 psi). This results in the force full ejection of the contamination, which was drawn into the venturi by a lesser pressure (e.g., a pressure of less than-12 psi).

The present disclosure entails a system and methodology coupled with a mechanical system that perpetually self-propagates its vacuum flow and pressure effectiveness. As outlined in the mechanical features described in FIGS. 2 and 3, this design constrains the inner diameter of the vacuum generator and the occluding purge device, enabling the automated cleaning of the entire system to remove the buildup of contaminants, best described as viscous sludge, as seen in FIG. 6.

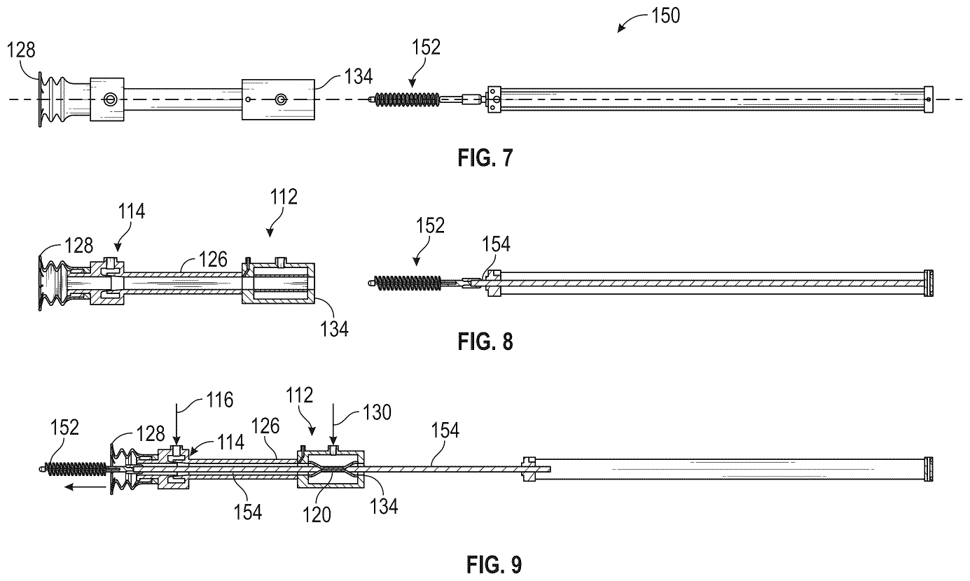

Referring to FIGS. 7-9, the disclosed occluding venturi system can further comprise a cleanout system 150, which can be automated as described below. Various cleanout systems can be used, including but not limited to pneumatic cylinders, linear actuators, hydraulically activated devices, or high-pressure water flush systems.

This embodiment diverges from the industry's standard pass-through venturi form by designing the venturi to conform to the methodology of sustaining operating performance versus peak performance. In addition, by maintaining the inside diameter and providing an occluding device that allows for manipulating the venturi profile, the system can receive a single linear-activated pipe brush that can be used to remove built-up sludge and any other foreign matter from the venturi.

For example, FIGS. 7-9 illustrate a cleanout system 150 that can be positioned adjacent the exit area 134 and extended through the venturi device. As shown in FIGS. 7-9, the cleanout system 150 can include a removal member 152 on a shaft 154 that permits the to be passed through the occluding device 112 and venturi 114, removing sludge, objects, and/or other contaminants 146. The term “removal member” refers to a component designed to physically remove or dislodge contaminants, debris, or residue from the interior surfaces of a system. For example, the removal member can comprise a scrubbing member such as brushes with bristles made of materials like nylon, metal, or rubber; abrasive pads for scrubbing hardened deposits; or other cleaning members such as wipers constructed from flexible materials such as silicone or rubber. The removal member can be tailored to the specific cleaning requirements of the system, ensuring effective removal of contaminants while minimizing wear on the system's components.

It should be noted that the cleanout system 150 can be used separately or simultaneously with the occluding purge system. For example, as shown in FIG. 9, the occluding purge venturi can operate to sealing the exhaust line to atmosphere, expelling air from the system once active with by the pneumatic input. In this manner, if there is a clog inside the vacuum port that the cleanout device can't clear, the system still retains the ability to equalize the internal pressure to the operating pressure of the input (e.g., around 90 psi), resulting in the explosive ejection of the contamination.

The complete embodiment can be configured for use with a robotic system, such as, for example, a Delta, 6-Axis, or Gantry robot, enabling the vacuum-based pick-and-place application to sustain grasping efficiency within high-particulate-matter-rich air environments not conducive to industry-standard equipment.

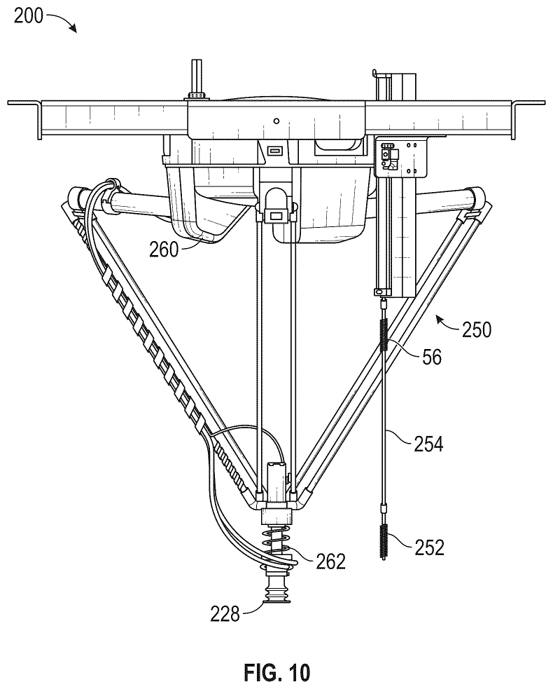

FIG. 10 outlines a robotic system 200 equipped with the disclosed design capable of continuous operation at peak performance. The physical controlling equipment 260 utilizes the occluding purge venturi system 262 in a pick-and-place application. The automated cleaning system 250 can integrated so that the physical movement of the end-of-arm tooling and the range of interference of the robotic arms will never collide with the equipment when the device is in its retracted state, while within the robot's range. Thus, when the maintenance procedure is activated, the robot will move to the maintenance location, and the device can clean the occluding purge venturi before returning to operation.

In some embodiments, the automated cleaning system is configured to activate upon detection by one or more sensors, such as the sensors discussed above, of a predetermined level of contaminant accumulation within the venturi module.

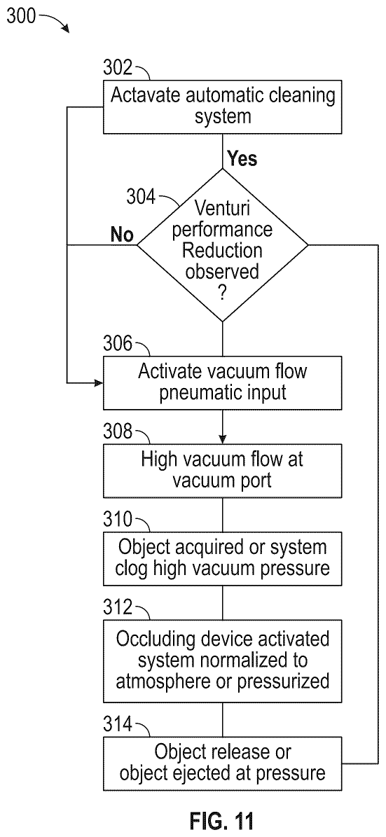

FIG. 11 illustrates a method 300 for maintaining venturi performance and object manipulation efficiency. The method 300 can be implemented by the systems disclosed herein. At step 304, the method 300 evaluates whether a reduction in venturi performance is observed. This decision point determines whether the system requires intervention to restore optimal functionality. If a reduction is detected, the method proceeds to step 306; otherwise, the process proceeds to step 302. At step 302, the automated cleaning system 302 is activated. This step ensures that any accumulated contaminants within the venturi module are removed, maintaining the system's efficiency and preventing potential blockages. After cleaning the method can proceed to step 306 for operation of the system. Step 306 provides for activation of the vacuum flow. This step initiates the generation of vacuum pressure and flow necessary for object acquisition and manipulation. At step 308, the method 300 establishes high vacuum flow at the vacuum port 308. At step 310, an object is acquired or a system clog occurs, resulting in high vacuum pressure. At step 312, the occluding device 312 is activated and at step 314, as a result of activation of the occluding device, the object or blockage is released or ejected.

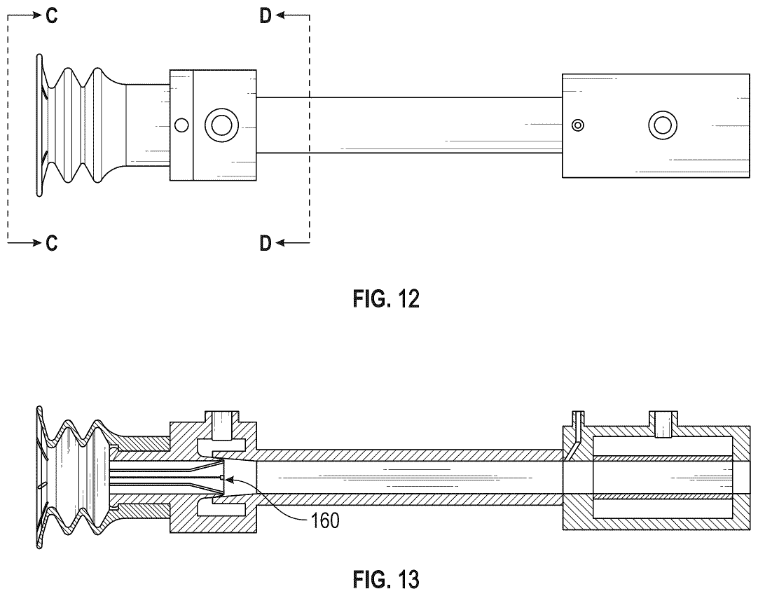

FIG. 12 shows a schematic diagram of a system 400 for high-speed object manipulation using a venturi-based vacuum system. The system 400 comprises a venturi module 414, one or more sensors (e.g., 440, 442), a controller 470, an occluding purge assembly 412, one or more sensors associated with the occluding purge assembly (e.g., 444), and an automated cleanout system 450. As described herein, the venturi module 414 is configured to generate a vacuum flow for object acquisition, while the occluding purge assembly 412 is designed to selectively seal the exhaust port from atmospheric exposure. The controller 470 manages the operation of the system, including the activation of the occluding purge assembly 112 and the ACS 450.

The venturi module 414 includes one or more sensors that are configured to monitor pressure parameters (and/or other relevant parameters) at various points within the module. The pressure parameters that are sensed herein are measurements of force exerted by air or gas within a system, which can include positive pressure, negative pressure, or both positive and negative pressure. Positive pressure occurs when the pressure within the system exceeds atmospheric pressure, typically measured in units such as pascals (Pa) or pounds per square inch (psi). Negative pressure, often referred to as vacuum pressure, occurs when the pressure within the system is below atmospheric pressure, creating a suction effect. In the context of the venturi module 414, sensors are configured to monitor these pressure parameters at various points, providing real-time data to the controller 470 to ensure proper system operation, detect blockages, and facilitate maintenance.

The controller 470 serves as the main processing unit of the system 400, managing the operations of the venturi module 414, occluding purge assembly 412, and automated cleanout system 450. The controller 470 receives input from the one or more sensors (e.g., 440, 442, and 444), enabling the detection of blockages or performance issues within the system. Based on this input, the controller 470 can activate the occluding purge assembly 412 to seal the exhaust port or initiate the automated cleanout system 450 to conduct cleaning operations. For example, when activated by the controller 470, the occluding purge assembly 412 seals the exhaust port, allowing for the redirection of compressed air to clear blockages. Additionally, the cleanout system can be activated by the controller 470 based on sensor input, ensuring that any accumulated contaminants are removed from the system. This automated approach minimizes downtime and enhances the overall performance of the vacuum system.

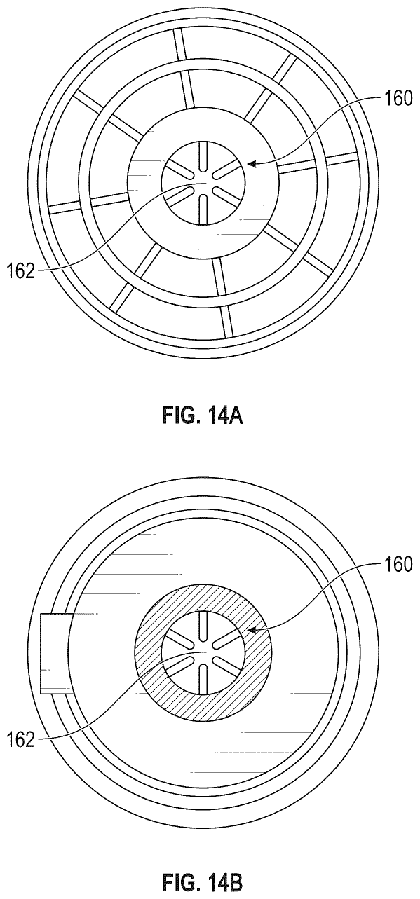

FIGS. 12 and 13 illustrate a device similar to that shown in FIGS. 2 and 3. However, the device of FIGS. 12 and 13 is different in that it includes a screen 160 within the inlet pipe. As shown in FIG. 14, for example, screen 160 is positioned within the inlet pipe and has a tapered configuration on the venturi side to enhance its functionality and compatibility with the cleaning system.

FIGS. 14A and 14B are cross-sectional views taken along lines C-C and D-D, respectively, in FIG. 12. As shown in FIG. 13, the screen 160 is integrated into the inlet part of the venturi and configured to restrict the ingress of large debris or malleable contaminants while maintaining compatibility with the clean out systems described herein. As shown in FIGS. 14A and 14B, the screen features an open-center area 162, which allows the core component of the removal member to pass through the screen without obstruction during cleaning operations. For example, if the removal member is a brush, the open-center configuration ensures that the brush can effectively traverse the venturi module, removing accumulated contaminants from the interior surfaces, while the screen continues to filter out unwanted materials.

Although the screen is shown positioned within the inlet area, it should be understood that the screen can be positioned elsewhere within the system, such as anywhere within exhaust line 126.

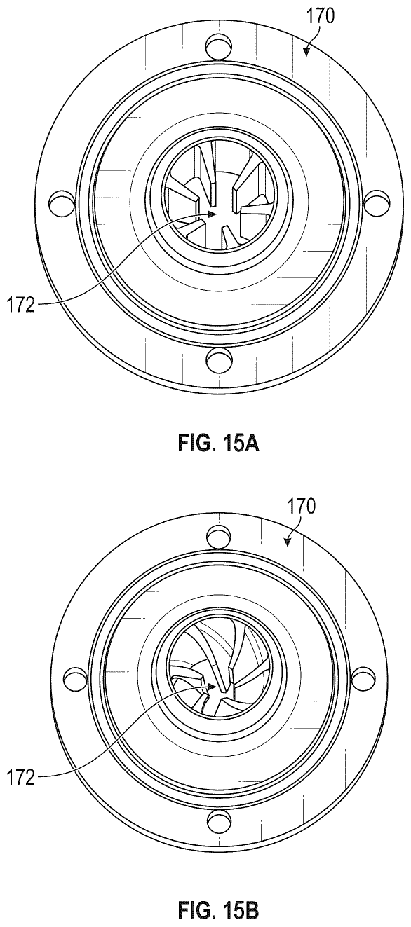

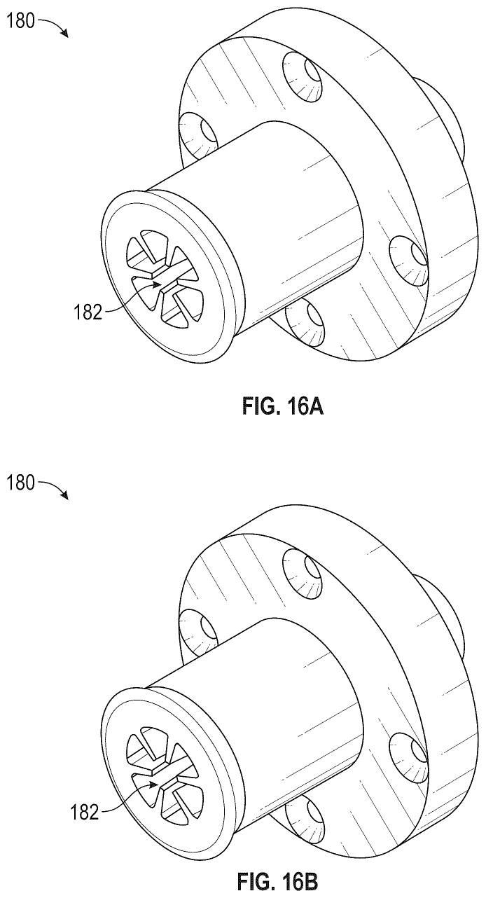

The screens can be implemented in various shapes and configurations. For example, FIGS. 14A and 14B illustrate a screen 170 that is substantially straight. That is, a plurality of fins extend towards the open-center area 172 in a substantially straight manner along an axial length of the screen (e.g., from a first end to a second end). In contrast, FIGS. 15A and 15B illustrates a screen 180 in which the fins that extend to the open-center area 182 are not straight along the length of the screen. For example, in FIGS. 15A and 15B, screen 180 has a helical shape (e.g., a spiral structure) in which the plurality of fins change their orientation along an axial length of the screen. The helical shape provides additional surface area for filtering contaminants, which can be particularly useful in applications where higher filtration efficiency is required or where debris tends to accumulate in a non-linear manner, (e.g., film or other elongate contaminants).

In each of the above screens, the screen is configured with an open area that allows the core component of the removal member, such as a brush or wiper, to pass through unobstructed during cleaning operations. fashion. In the disclosed embodiments, the open area is in a center portion of the screen; however, it should be understood that the open area can be offset from the center if desired.

As discussed above, the screen member can be integrated into the venturi system to improve filtration efficiency while minimizing vacuum flow loss. By utilizing a hollow core with no interconnecting fins, the screen ensures that the vacuum flow remains unobstructed, maintaining the system's performance during normal operation. The hollow core also allows the cleanout system (e.g., a removal member) to pass through unimpeded during cleaning cycles, ensuring effective removal of contaminants without compromising the screen's functionality.

As discussed above, the internal fins of the screen can have various shapes, including linear and non-linear shapes. In addition, in some embodiments, the fins can be sized such that a ratio of an axial length of the internal fins to an internal diameter of the pipe is in a range of 1:1 to 3:1, or 1.5:1 to 2.5:1, such as 2:1. This extended fin length enhances the screen's ability to capture and retain contaminants, particularly malleable or irregular debris, while maintaining compatibility with the cleanout system.

The fins can also be chamfered on the exhaust port side of the device to further improve functionality by preventing entanglement of contaminants and facilitating their expulsion back through the tube during cleaning operations. This chamfered design helps reduce the likelihood that debris becomes lodged within the screen, which could otherwise impede the cleaning process or reduce system efficiency.

For the helix screen configuration, the pitch can be selected as a factor of length to prevent elongate objects from passing through without contacting the side walls. For example, in some embodiments, the pitch can be selected so that a coffee straw or similar object cannot fall straight through the screen unless it is perfectly aligned with the center. This helps ensures that elongated debris is intercepted and retained by the screen, preventing it from entering the venturi module and causing blockages. The helix screen's spiral structure also provides additional surface area for filtration, making it particularly effective in environments with high particulate matter or irregular debris.

### Additional Examples

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.
1: An apparatus for high-speed object apparatus may include: a venturi module configured to generate a vacuum flow for object acquisition, the venturi module including an inlet port to receive compressed air, a vacuum port that includes a suction member, and an exhaust port; an occluding purge assembly having a passageway and being operably coupled to the venturi module, the occluding purge assembly including an occluding device configured to selectively close the passageway to seal the exhaust port from atmospheric exposure; a controller configured to cause the occluding purge assembly to move from a first configuration in which the passageway of the occluding purge assembly is open and a second configuration in which the passageway of the occluding purge assembly is closed.
2: The apparatus as paragraph 1 describes, where the occluding purge assembly may include a pinch valve.
3: The apparatus as either of paragraphs 1 or 2 describe, where the occluding purge assembly include a flow limiting device, such as a pinch valve, an angle seat valve, a slide gate, and/or an iris diaphragm valve.
4: The apparatus as any of paragraphs 1-3 describe, where the occluding purge assembly, when in the closed configuration, seals the exhaust port from atmospheric exposure such that the venturi module operates as a pressure vessel having an internal static pressure corresponding to the compressed air supplied to the inlet port.
5: The apparatus as any of paragraphs 1-4 describe, further may include a sensor system that includes one or more sensors configured to monitor at least one pressure parameter at the vacuum port, the exhaust port, or both, where the sensor system is operatively coupled to the controller.
6: The apparatus as any of paragraphs 1-5 describe, where the controller is configured to activate the occluding purge assembly in response to a detected blockage within the venturi module based on an input received from the one or more sensors.
7: The apparatus as any of paragraphs 1-6 describe, where the venturi module has a substantially constant inside diameter from the inlet port to the exhaust port.
8: The apparatus as any of paragraphs 1-7 describe, further may include an automated cleaning system operatively coupled to the venturi module, where the automated cleaning system includes a cleaning mechanism configured to remove accumulated contaminants from the venturi module.
9: The apparatus as any of paragraphs 1-8 describe, where the cleaning mechanism may include a removal member, such as a scrubbing or wiping member, that is configured so that it can pass through the occluding purge assembly to clean an interior surface of the venturi module.
10: The apparatus as any of paragraphs 1-9 describe, where the automated cleaning system is configured to activate upon detection, by one or more sensors, of a predetermined level of contaminant accumulation within the venturi module.
11: The apparatus as any of paragraphs 1-10 describe, where the occluding purge assembly is actuated by a pneumatic input.
12: The apparatus as any of paragraphs 1-11 describe, where the occluding purge assembly is actuated by a mechanical input.
13: The apparatus as any of paragraphs 1-12 describe, further may include an occlusion sensor integrated with the occluding purge assembly, the occlusion sensor being configured to determine a sealing effectiveness of the occluding purge assembly when in the second configuration.
14: The apparatus as any of paragraphs 1-13 describe, further may include a secondary compressed air input into the venturi module, where the secondary compressed air input is configured to supplement the primary compressed air supply during a purging process.
15. The apparatus as any of paragraphs 1-14, further comprising a screen member with an open area that is sized to allow the removal member to pass through the open area, the screen member can optionally include a plurality of fins that extend inward to define the open area, and the plurality of fins can extend linearly or non-linearly along an axial length of the screen member. Optionally, the plurality of fins can have a straight shape, helical shape, or other non-linear and/or curved shape.
16: A method for purging contaminants from a venturi-based vacuum system for high-speed object manipulation, may include: supplying compressed air to a venturi device having an inlet port configured to receive the compressed air, a vacuum port having a suction member for object acquisition, and an exhaust port open to atmospheric exposure; generating a vacuum flow through the venturi device to acquire an object or to admit contaminants into the system; detecting a formation of a blockage within the venturi device indicative of contaminant accumulation or object retention; while maintaining the supplied compressed air, activating an occluding purge device operably coupled to the venturi device, the occluding purge device being configured to seal the exhaust port from atmospheric exposure, causing the compressed air to be redirected from towards the vacuum port; and expelling the object or contaminant from the vacuum port.
17: The method as paragraph 16 describes, further may include: monitoring one or more pressure parameters at the vacuum port, the exhaust port, or both, using one or more sensors.
18: The method as either of paragraphs 16 or 17 describe, where the occluding purge device is actuated by a pneumatic input.
19: The method as any of paragraphs 16-18 describe, where: the occluding purge device is actuated by a mechanical input.
20: The method as any of paragraphs 16-19 describe, further may include: providing a secondary compressed air input to supplement the primary compressed air supply during the purging process.
21: The method as any of paragraphs 16-20 describe, further may include: determining a sealing effectiveness of the occluding purge device by one or more sensors integrated with the occluding purge device.
22: The method as any of paragraphs 16-21 describe, further may include: operating an automated cleaning system to remove accumulated contaminants from the venturi device subsequent to the expelling step.
23: The method as any of paragraphs 16-22 describe, where detecting the formation of a blockage may include comparing a measured pressure differential between the vacuum port and the exhaust port to a predetermined threshold indicative of contaminant accumulation.

In view of the many possible examples to which the principles of the disclosure may be applied, it should be recognized that the illustrated examples are only preferred examples and should not be taken as limiting the scope. Rather, the scope is defined by the following claims.

1. An apparatus for high-speed object apparatus comprising:
a venturi module configured to generate a vacuum flow for object acquisition, the venturi module including an inlet port to receive compressed air, a vacuum port that includes a suction member, and an exhaust port;
an occluding purge assembly having a passageway and being operably coupled to the venturi module, the occluding purge assembly including an occluding device configured to selectively close the passageway to seal the exhaust port from atmospheric exposure;
a controller configured to cause the occluding purge assembly to move from a first configuration in which the passageway of the occluding purge assembly is open and a second configuration in which the passageway of the occluding purge assembly is closed.

2. The apparatus of claim 1, wherein the occluding purge assembly comprises a flow limiting device.

3. The apparatus of claim 2, wherein the flow limiting device is selected from the group consisting of a pinch valve, an angle seat valve, a slide gate, and an iris diaphragm valve.

4. The apparatus of claim 1, wherein the occluding purge assembly, when in the closed configuration, seals the exhaust port from atmospheric exposure.

5. The apparatus of claim 1, further comprising a sensor system that includes one or more sensors configured to monitor at least one pressure parameter at the vacuum port, the exhaust port, or both, wherein the sensor system is operatively coupled to the controller.

6. The apparatus of claim 5, wherein the controller is configured to activate the occluding purge assembly in response to a detected blockage within the venturi module based on an input received from the one or more sensors.

7. The apparatus of claim 1, further comprising an automated cleaning system operatively coupled to the venturi module, wherein the automated cleaning system includes a cleaning mechanism configured to remove accumulated contaminants from the venturi module.

8. The apparatus of claim 7, wherein the cleaning mechanism comprises a removal member mounted on a shaft, the removal member being configured so that it can pass through the occluding purge assembly to clean an interior surface of the venturi module.

9. The apparatus of claim 8, further comprising a screen member with an open area that is sized to allow the removal member to pass through the open area.

10. The apparatus of claim 9, wherein the screen member comprises a plurality of fins that extend inward to define the open area.

11. The apparatus of claim 10, wherein the plurality of fins extend linearly along an axial length of the screen member.

12. The apparatus of claim 10, wherein the plurality of fins extend non-linearly along an axial length of the screen member.

13. The apparatus of claim 12, wherein the plurality of fins have a helical shape.

14. The apparatus of claim 7, wherein the automated cleaning system is configured to activate upon detection, by one or more sensors, of a predetermined drop in performance level.

15. The apparatus of claim 14, wherein the predetermined drop in performance level indicates a threshold level of contaminant accumulation within the venturi module.

16. The apparatus of claim 1, wherein the occluding purge assembly is actuated by an electrical input that activates a pneumatic or mechanical actuator.

17. The apparatus of claim 1, further comprising an occlusion sensor integrated with the occluding purge assembly, the occlusion sensor being configured to determine a sealing effectiveness of the occluding purge assembly when in the second configuration.

18. The apparatus of claim 1, further comprising a secondary compressed air input into the venturi module, wherein the secondary compressed air input is configured to supplement the primary compressed air supply during a purging process.

19. A method for purging contaminants from a venturi-based vacuum system for high-speed object manipulation, comprising:
supplying compressed air to a venturi device having an inlet port configured to receive the compressed air, a vacuum port having a suction member for object acquisition, and an exhaust port open to atmospheric exposure;
generating a vacuum flow through the venturi device to acquire an object or to admit contaminants into the system;
detecting a formation of a blockage within the venturi device indicative of contaminant accumulation or object retention;
while maintaining the supplied compressed air, activating an occluding purge device operably coupled to the venturi device, the occluding purge device being configured to seal the exhaust port from atmospheric exposure, causing the compressed air to be redirected from towards the vacuum port; and
expelling the object or contaminant from the vacuum port.

20. The method of claim 19, further comprising:
monitoring one or more pressure parameters at the vacuum port, the exhaust port, or both, using one or more sensors.

21. The method of claim 19, wherein the occluding purge device is actuated by an electrical input that activates a pneumatic or mechanical actuator.

22. The method of claim 19, further comprising:
providing a secondary compressed air input to supplement the compressed air supplied during the expelling step.

23. The method of claim 19, further comprising:
determining a sealing effectiveness of the occluding purge device by one or more sensors integrated with the occluding purge device.

24. The method of claim 19, further comprising:
operating an automated cleaning system to remove accumulated contaminants from the venturi device.

25. The method of claim 24, wherein the operation of the automated cleaning system comprises:
passing a removal member mounted on a shaft through the occluding purge device to clean an interior surface of the venturi device.

26. The method of claim 25, wherein the operation of the automated cleaning system further comprises:
passing the removal member through an open area of a screen member.

27. The method of claim 19, wherein detecting the formation of a blockage comprises comparing a measured pressure differential between the vacuum port and the exhaust port to a predetermined threshold indicator of impaired performance.
